(19) United States
(12) Patent Application Publication
(10) Pub. No.: US 2010/0067423 A1
(43) Pub. Date: Mar. 18, 2010

(54) POWER-SAVE (PS)-POLL SUBSTITUTION

(75) Inventors: Yanjun SUN, Richardson, TX (US); Ariton E. XHAFA, Plano, TX (US); Xiaolin LU, Plano, TX (US)

Correspondence Address: TEXAS INSTRUMENTS INCORPORATED, P O BOX 655474, M/S 3999, DALLAS, TX, 75265, US

(73) Assignee: TEXAS INSTRUMENTS INCORPORATED, Dallas, TX (US)

(21) Appl. No.: 12/559,695

(22) Filed: Sep. 15, 2009

Related U.S. Application Data
(60) Provisional application No. 61/097,081, filed on Sep. 15, 2008.

(51) Int. Cl. G08C 17/00

(52) U.S. Cl. 370/311

(57) ABSTRACT

In accordance with at least some embodiments, a system comprises an access point and a station in communication with the access point. The station has at least two network technology subsystems subject to coexistence interference. The station selectively implements Power Save (PS)-Poll substitution (PSPS) logic to handle communications between the station and the access point.

### CROSS-REFERENCE TO RELATED APPLICATIONS

This application is a non-provisional application claiming priority to provisional application Ser. No. 61/097,081, filed on Sep. 15, 2008, entitled “PSPS: PS-Poll Substitution In Coexisting Wireless Networks,” the teachings of which are incorporated by reference herein.

### BACKGROUND

Next generation mobile devices implement a plurality of wireless technologies to access different networks such as WiMAX networks, WLAN networks, LTE networks, Wireless USB or Bluetooth (BT) networks, etc. Such devices are referred to herein as “combo” devices. While increased access to these technologies benefit users and operators alike, interference among different technologies, particularly onboard a single combo device, introduces difficulties during concurrent operation of these technologies. For example, and as illustrated in FIG. 1, WLAN (in 2.4-2.5 GHz) and WiMAX (2.3-2.4 GHz and 2.5-2.7 GHz) technologies operate at relatively close frequency bands with respect to each other—so close, in fact, that the out-of-band emission by either technology may saturate the receiver of the other technology resulting in potential blocking. Thus, the interference between different technologies operating in the same combo device creates coexistence problems.

Time multiplexed operation has been proposed to coordinate BT radio and WLAN radio in a single mobile device (co-existence node). Under such operation, the CTS2Self mechanism may be used to protect both BT and WLAN performance in order to avoid the avalanche effect (TI Connectivity Solutions: “WiMAX/WLAN and BT coexistence”, 2007). The protection mechanism using CTS2Self frames, however, could greatly reduce the channel utilization of WLAN, as a CTS2Self frame disables transmissions from all WLAN neighbors during the following BT activity. For example, if the BT radio has HV3 traffic and a co-existence node generates a CTS2Self frame once every 3.75 ms, the resulting channel utilization is less than 67% because transmissions from neighbors are disabled for at least 1.25 ms. Channel utilization could be worse when CTS2Self based protection is used by multiple mobile devices associated with the same AP.

In order to reduce the number of CTS2Self frames generated while avoiding the avalanche effect, a scheme that takes advantage of Power Save (PS) mode has been proposed. FIG. 2 shows this scheme in which a co-existence node (STA) stays in PS mode so that WLAN Access Point (AP) cannot transmit a data packet to the STA without having received a PS-Poll frame from the STA first. As shown in FIG. 2, after the STA has received a beacon indicating a pending data to the STA at the AP, the STA transmits a PS-Poll to notify the AP that it is active to receive the data. Upon receiving this PS-Poll, the AP replies with an ACK after a SIFS delay. Then the data is sent at AP's convenience and the STA confirms a successful receipt with an ACK. Although the 802.11 standard allows an AP to reply to the PS-Poll with a data instead of the ACK as in FIG. 2 (802.11 Spec), most products take the approach shown in FIG. 2 for better protection of the data transmission and lower complexity in implementation. Since the AP cannot transmit any data before receiving a PS-Poll from the STA, no CTS2Self frame is needed and the avalanche effect is avoided.

The overhead caused by the PS-Poll technique of FIG. 2 is not negligible since it is present with each data delivery. More specifically, although the body of a PS-Poll is only 20 bytes, the STA needs to spend extra time on backoffs, DIFS, SIFS, preamble transmissions and ACK receipt associated with the PS-Poll. In addition, if a PS-Poll and the following ACK are transmitted at the control data rate of a WLAN, the time interval occupied by the PS-Poll increases. The overhead associated with each PS-Poll handshake (including backoff procedures associated with PS-Poll) could take the same amount of time as delivering a data frame of several hundred bytes or more, depending on WLAN radio configurations and channel conditions.

Further, the PS-Poll handshake cannot provide the desired protection if the PS-Poll handshake is performed a short time before the STA radio is assigned to Bluetooth. These scenarios are illustrated in FIG. 3 and FIG. 4.

In FIG. 3, after receiving the PS-Poll from the STA, the AP fails to deliver the data before the STA grants the medium to its BT radio, due to busy medium caused by other traffic or STAs in the network. In order to prevent the AP from transmitting data when the medium is used by the BT radio, the STA needs to transmit a CTS2Self before granting the medium to the BT radio. As the data transmission following a PS-Poll exchange has to compete for the medium with packets of other flows, the timing of actual transmission is unpredictable. This is true especially when the BT radio has voice traffic such as HV3. In such case, the AP has to grant the medium to the BT radio at a high frequency, making it very hard to deliver the data before the medium is granted to the BT radio. As a result, in addition to the overhead of PS-Poll exchange, the STA still needs to transmit a CTS2Self for protection.

Even when there is no other traffic in a WLAN, multiple pending data at an AP could trigger CTS2Self for protection as illustrated in FIG. 4. The AP sets the “more data” bit of the first data it delivers to the STA to indicating more pending data at the AP. Upon receiving this data, the STA generates another PS-Poll to retrieve the pending data. If the transmission of this PS-Poll takes place right before the medium is granted to the BT radio, a CTS2Self needs to be transmitted to avoid the avalanche effect. In summary, there is still a need for improved techniques to avoid the avalanche effect in devices with coexistent technologies.

### SUMMARY

In at least some embodiments, a system includes an access point and a station in communication with the access point. The station has at least two network technology subsystems subject to coexistence interference. The station selectively implements Power Save (PS)-Poll substitution (PSPS) logic to handle communications between the station and the access point.

In at least some embodiments, a communication device include a transceiver with a first wireless technology subsystem and a second wireless technology subsystem, the first and second wireless technology subsystems being subject to coexistence interference. To avoid an avalanche effect, the transceiver includes logic that selectively substitutes Power-Save (PS)-Poll transmission with upstream data frame transmission to indicate an active mode and a PS mode of the communication device.

In at least some embodiments, a method for a communication device includes determining whether an upstream data frame is available. If there is an available upstream data frame, the method includes selectively substituting Power-Save (PS)-Poll transmission with upstream data frame transmission to indicate an active mode and a PS mode of the communication device.

### BRIEF DESCRIPTION OF THE DRAWINGS

For a detailed description of exemplary embodiments of the invention, reference will now be made to the accompanying drawings in which:

FIG. 1 illustrates different network technologies and their operating bands;

FIG. 2 illustrates a Power Save (PS) mode scheme that avoids CTS2Self;

FIG. 3 illustrates an unavoidable CTS2Self transmission during a PS mode due to traffic;

FIG. 4 illustrates an unavailable CTS2Self transmission during a PS mode due to the timing of PS-Poll transmission;

FIG. 5 illustrates a PS-Poll substitution (PSPS) technique that does not avoid CTS2Self transmission in accordance with embodiments of the disclosure;

FIG. 6 illustrates a PSPS technique that avoids CTS2Self transmission in accordance with embodiments of the disclosure;

FIG. 7 illustrates a wireless local area network (WLAN) in accordance with an embodiment of the disclosure;

FIG. 8 illustrates an exemplary access point and/or wireless device in accordance with an embodiment of the disclosure;

FIG. 9 illustrates a simplified communication device in accordance with an embodiment of the disclosure; and

FIG. 10 shows a method for a communication device in accordance with an embodiment of the disclosure.

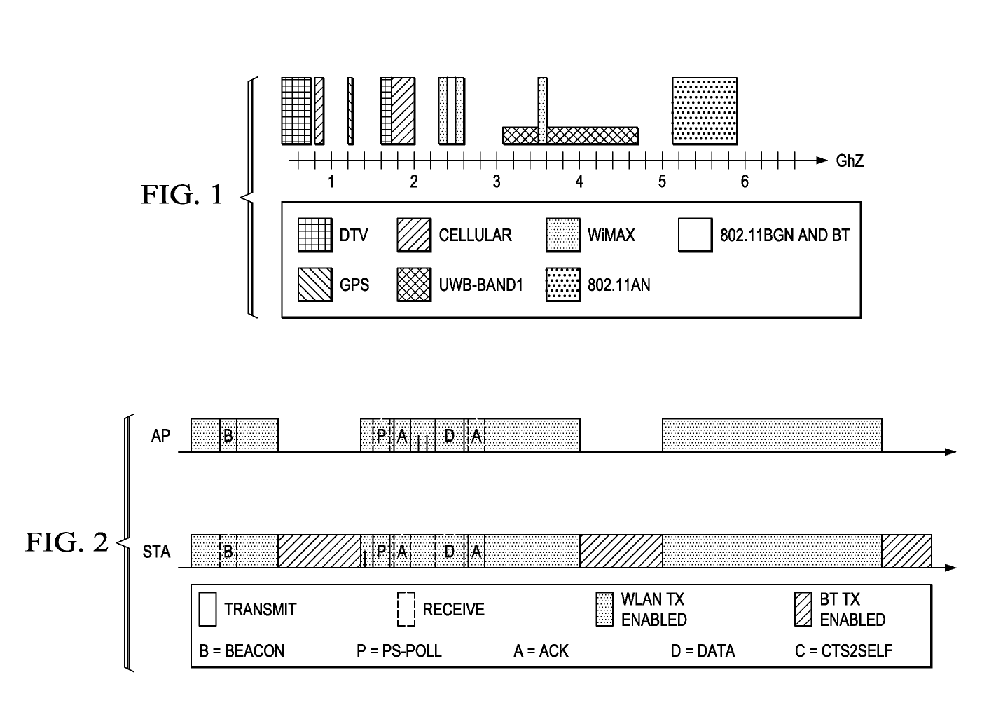

### NOTATION AND NOMENCLATURE

Certain terms are used throughout the following description and claims to refer to particular system components. As one skilled in the art will appreciate, companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect or direct electrical connection. Thus, if a first device couples to a second device, that connection may be through a direct electrical connection, or through an indirect electrical connection via other devices and connections. The term “system” refers to a collection of two or more hardware and/or software components, and may be used to refer to an electronic device or devices or a sub-system thereof. Further, the term “software” includes any executable code capable of running on a processor, regardless of the media used to store the software. Thus, code stored in non-volatile memory, and sometimes referred to as “embedded firmware,” is included within the definition of software.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

Embodiments of the disclosure are directed to communication systems having at least one “combo” device (i.e., a device having at least two dissimilar network technology subsystems that are subject to coexistence interference). As used herein, “coexistence interference” refers to interference that occurs during simultaneous emissions (e.g., out-of-band emissions by either technology may saturate the receiver of the other technology resulting in potential blocking). To avoid the avalanche effect in the combo device, embodiments of the disclosure opportunistically substitute a PS-Poll frame with an upstream data frame in order to retrieve pending data from the associated access point (AP). As used herein, an “upstream data frame” refers to a data frame transmitted by a combo device to the access point with which the combo device is associated. The disclosed “PS-Poll substitution” (PSPS) technique is motivated by the fact that CTS2Self is sometimes unavoidable and the overhead for PS-Poll and ACK exchange is sometimes large. If CTS2Self is unavoidable, it may be better for the WLAN radio of a combo device to switch to active mode, so that the medium time taken by PS-Poll and ACK exchange can be used to deliver more data frames.

In accordance with embodiments, the disclosed PSPS technique uses an upstream data frame to dynamically switch the power state of the WLAN radio. In this manner, the throughput for the STA is improved as well as the overall channel utilization for the whole WLAN. The disclosed PSPS technique only results in slight changes to queuing management and power mode management at the STA, making it independent from AP implementations. The benefits of the disclosed PSPS technique include: avoidance of avalanche effect in the WLAN network under light traffic load without using CTS2Self that could degrade performance a WLAN network; greater channel utilization for WLAN nodes under high traffic loads (compared to existing schemes) by reducing the use of PS-Poll and unnecessary CTS2Self; reduced downstream delivery latency caused by large beacon interval or missing beacons; and avoidance of packet drops due to buffer overflow at an AP.

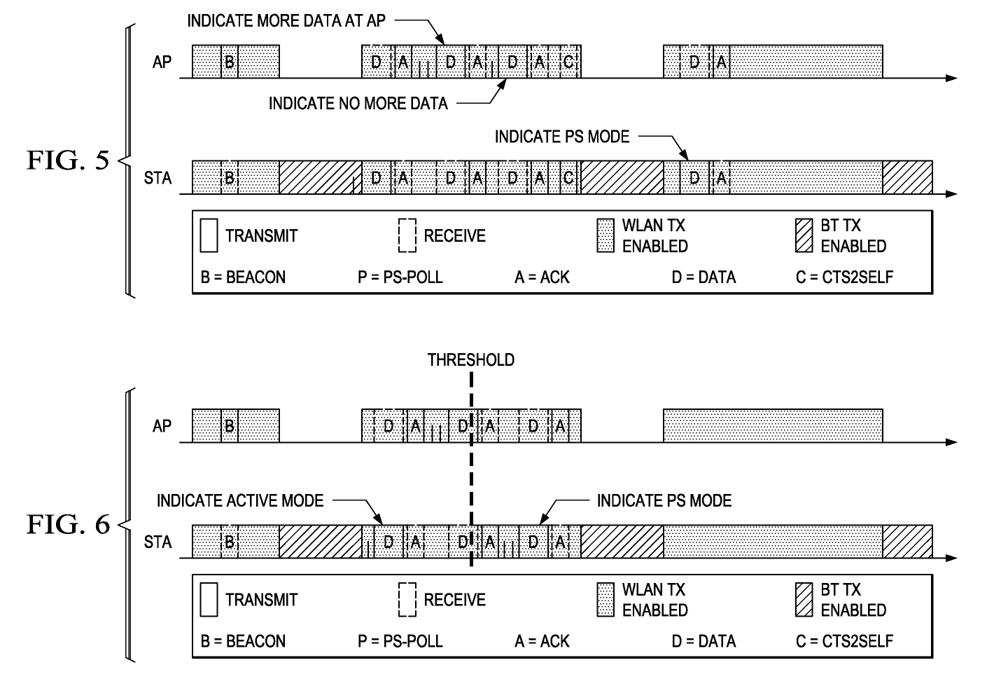

FIG. 5 illustrates a PS-Poll substitution (PSPS) technique that does not avoid CTS2Self transmission in accordance with embodiments of the disclosure. In FIG. 5, when the STA wants to use a PS-Poll to retrieve a pending from the AP, the STA checks whether it has an upstream data frame in its queue. If it does, instead of the PS-Poll frame, the STA transmits the data frame that indicates that the STA is in active mode. This allows the AP to transmit the data frames without requiring a PS-Poll. The STA stays in active mode until a data frame indicates that there is no more pending data at the AP. Then the STA transmits another upstream data frame to notify the AP that the STA has gone back to PS mode. If no upstream data frame exists or no upstream data frame is small enough to be successfully delivered before WLAN losses access to the medium, the STA may transmit a NULL frame instead. As no PS-Poll is exchanged, it makes more room for data exchange, which helps to achieve better channel utilization and to reduce delivery latency.

PSPS takes advantage of the fact that a STA often has bi-directional traffic. For example, many applications use transmission control protocol (TCP) connections, each of which at least transmits TCP data in one direction and TCP ACKs in the other direction. The PSPS technique substitutes PS-Poll transmission with actual data transmission opportunistically, reducing the overhead caused by PS-Poll exchange.

In FIG. 5, a CTS2Self is generated when the STA is about to grant the medium to the BT radio while there are more pending data frames at the AP. This is similar to PS-Poll based scenario shown in FIG. 4, as there is no constraint on when a PS-Poll can be transmitted. PSPS, however, puts a constraint on when a PS-Poll substitute can take place in order to avoid unnecessary CTS2Self.

FIG. 6 illustrates a PSPS technique that avoids CTS2Self transmission in accordance with embodiments of the disclosure. In FIG. 6, the PSPS technique maintains a threshold, before which PS-Poll substitution can occur, in order to avoid unnecessary CTS2Self transmissions. The threshold is defined as the offset from the beginning of a duration during which WLAN is granted the medium. This threshold provides sufficient time for the STA to switch back to PS mode. Beyond this threshold, the STA switches back to PS mode by transmitting to the AP either an upstream data frame, as illustrated in FIG. 6, or a NULL frame instead.

The threshold can be made adaptable to the traffic conditions in the network. For example, initially, the threshold could be set to the middle of the duration during which WLAN is granted the medium (i.e., half of the duration is normally long enough for the STA to switch back to PS mode). When the STA succeeds in switching to the PS mode before the medium is granted to the BT radio, the threshold is moved towards the end of the duration. Otherwise, the threshold is moved towards the beginning of the duration. In order for the STA to transmit at least one frame to the AP and to receive the corresponding ACK, a limit is placed beyond which the threshold cannot be moved towards the end of the duration. PSPS can also be used by a STA to probe pending data at the associated AP opportunistically, in order to reduce delivery latency and avoid packet drops at the AP due to buffer overflow.

When PS mode is used, a packet may experience long delays as transmission is triggered by beacons from an AP. Beacons are generated by the AP at fixed time intervals, which are usually in the order of hundreds of microseconds. If a packet arrives at the AP right after a beacon transmission, the AP cannot notify the corresponding STA until the next beacon transmission. Such long latency may occur even if a node uses a PS-Poll to retrieve pending data at the AP. For example, consider the scenario where a new data frame arrives immediately after the last pending data frame was transmitted to the AP. In this scenario, the “more data” bit of the transmitted data frame is not set and thus the STA goes to sleep. As a result, the new data frame has to wait in the buffer until next beacon transmission. Frequency delays/latencies for the data packets implies that many packets could be discarded by the AP if the STA does not retrieve these packets fast enough, since the AP usually has a limited buffer size. This is more likely to happen for a combo device as described herein, especially if the combo device has missed several beacons in a row due to BT activity.

The disclosed PSPS technique enables opportunistic retrieval of pending data at the AP in order to reduce packet delivery latency due to large beacon intervals and to reduce packet drops due to buffer overflow at the AP. PSPS can be applied even without receiving a beacon that indicates pending data at the AP. In such case, PSPS switches the STA into active state using one upstream data frame and then switches the STA back to PS mode again using another upstream data frame or a NULL frame. During the STA's active state, the AP can transmit any pending data to the STA. In at least some embodiments, heuristics are used to control the rate of such opportunistic probing. For example, as more downstream data frames are received during a beacon interval, the frequency of using PSPS for probing can increase.

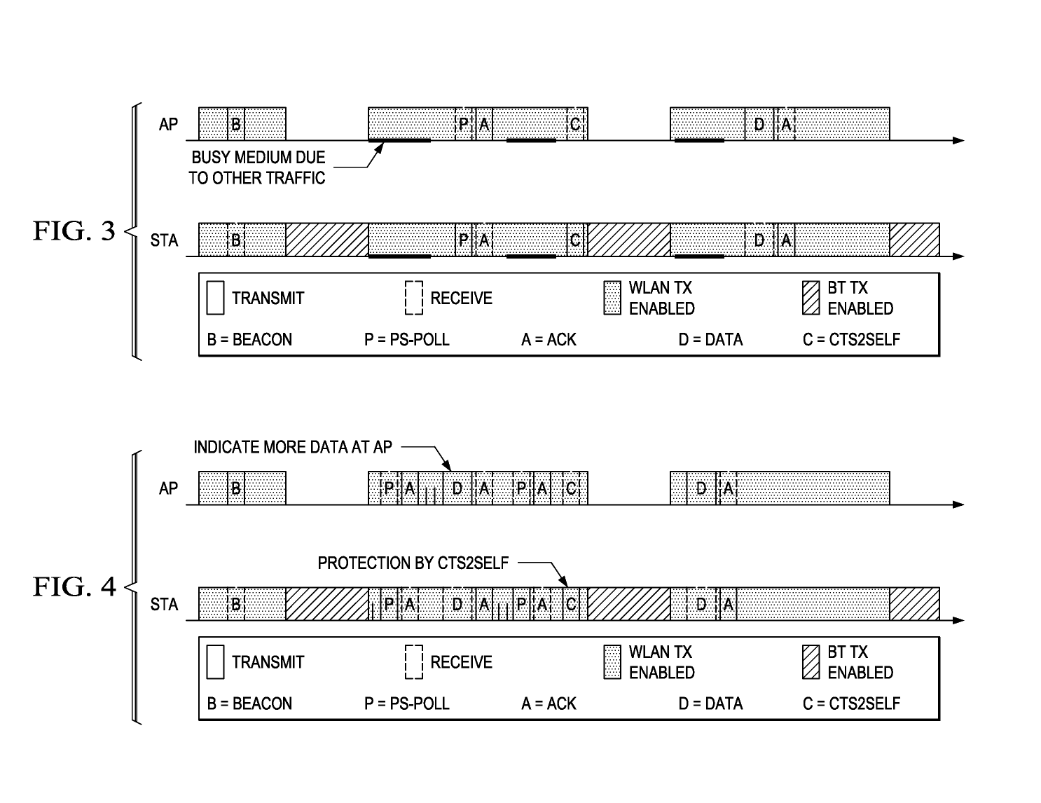

In at least some embodiments, implementing PSPS only requires modifications at the MAC layer of a STA. The only changes needed at the STA is to search for upstream traffic packets and to create a header for upstream data packet transmission that indicates the PS mode of the STA. If the STA has such a packet in its queue before the threshold and PS-Poll is the next packet to be transmitted, the STA may transmit the current upstream data packet as a substitute for the PS-Poll. If no upstream data packet in the queue is found for the STA, then the STA may implement a PS-Poll technique such as those shown in FIGS. 2-4. In such case, the PS mode bit is set in all outgoing frames.

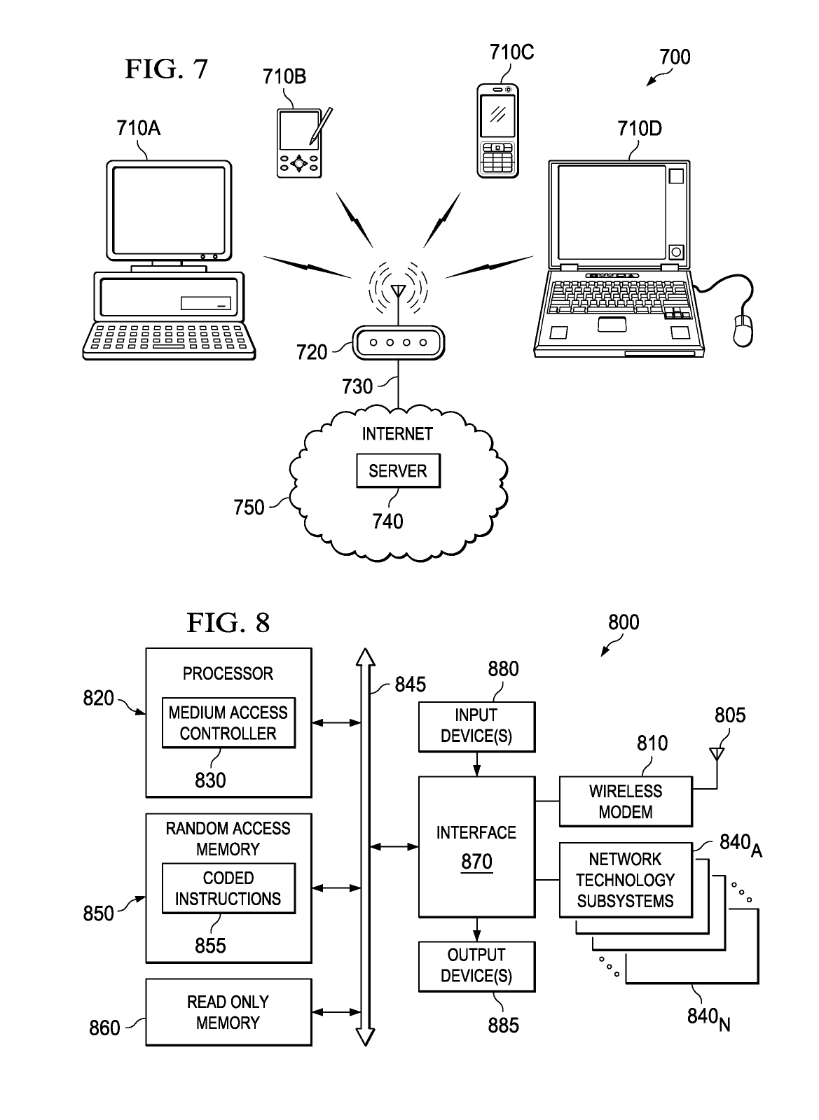

FIG. 7 illustrates a wireless local area network (WLAN) 700 in accordance with an embodiment of the disclosure. To provide wireless data and/or communication services (e.g., telephone services, Internet services, data services, messaging services, instant messaging services, electronic mail (email) services, chat services, video services, audio services, gaming services, etc.), the WLAN 700 comprises an access point (AP) 720 and any of a variety of fixed-location and/or mobile wireless devices or stations (STAs) (referred to individually herein as device, station, STA or device/station), four of which are respectively designated in FIG. 7 with reference numerals 710A, 710B, 710C and 710D. It should be appreciated that the network 700 is meant to be illustrative and not exhaustive. For example, it should be appreciated that more, different or fewer communication systems, devices and/or paths may be used to implement embodiments. Exemplary devices 710 include any variety of personal computer (PC) 710A with wireless communication capabilities, a personal digital assistant (PDA) or MP3 player 710B, a wireless telephone 710C (e.g., a cellular phone, a smart phone, etc.), and a laptop computer 710D with wireless communication capabilities. At least one of AP 720 and STAs 710A-710D are preferably implemented in accordance with at least one wired and/or wireless communication standard (e.g., from the IEEE 802.11 family of standards). Further, at least one device 710 comprises a combo device with a plurality of wireless network technology subsystems onboard.

In the example of FIG. 7, to enable the plurality of devices/STAs 710A-710D to communicate with devices and/or servers located outside WLAN 700, AP 720 is communicatively coupled via any of a variety of communication paths 730 to, for example, any of a variety of servers 740 associated with public and/or private network(s) such as the Internet 750. Server 740 may be used to provide, receive and/or deliver services such as data, video, audio, telephone, gaming, Internet, messaging, electronic mail, or other services. Additionally or alternatively, WLAN 700 may be communicatively coupled to any of a variety of public, private and/or enterprise communication network(s), computer(s), workstation(s) and/or server(s) to provide any of a variety of voice service(s), data service(s) and/or communication service(s).

In accordance with at least some embodiments, at least one of the STAs 710A-710D is a combo device that implements the disclosed PSPS technique (i.e., the combo device is a “PSPS STA”. A PSPS STA implements PSPS logic to handle communications between the PSPS STA and the access point 720. More specifically, PSPS logic may perform various operations such as determining if an upstream data frame is available for transmission from the PSPS STA to the access point 720. If the PSPS logic determines that upstream data frames are not available for transmission from the PSPS STA to the access point 720, the PSPS logic may implement a PS-Poll technique for communications between the station and the access point. If there are available upstream data frames and the access point 720 has indicated that there is pending data for the PSPS STA, the PSPS logic selectively causes an available upstream data frame to indicate to the access point 720 that the PSPS STA is in an active mode. Alternatively, if there are available upstream data frames and the access point 720 has indicated that there is no pending data for the PSPS STA, the PSPS logic selectively causes an available upstream data frame to indicate to the access point 720 that the PSPS STA is in a PS mode.

In accordance with at least some embodiments, the PSPS logic modifies a header of an upstream data frame to indicate the PSPS STA is in the active mode or the PS mode. As an example, in 802.11 WLAN, the PSPS logic may set the Pwr Mgt bit (B12) to 0 in the frame control field of a data frame (shown below) to indicate the active mode. On the contrary, if the Pwr Mgt bit is set to 1, the PSPS logic indicates that the transmitting node is in PS mode.

Header Modification Example

| | | | | | | | | | | | | | |
|---|---|---|---|---|---|---|---|---|---|---|---|---|---|
| B0 | B1 | B2 | B3 | B4 | B7 | B8 | B9 | B10 | B11 | B12 | B13 | B14 | B15 |

| | | | | | | | | | | |
|---|---|---|---|---|---|---|---|---|---|---|
| Protocol | Type | Subtype | To | From | More | Retry | Pwr | More | Protected | Order |
| Version | | | DS | DS | Frag | | Mgt | Data | Frame | |

In at least some embodiments, the PSPS logic maintains a threshold, before which transmission of PSPS packets is permitted and after which transmission of PSPS packets is avoided. The threshold may have a default value based on a predetermined medium grant duration (e.g., the middle of the predetermined medium grant duration may be selected as the default threshold). Additionally or alternatively, the threshold may be updated (i.e., moved forward or back in the medium grant duration) based on traffic conditions.

The PSPS technique described herein may be implemented on any general-purpose computer with sufficient processing power, memory resources, and network throughput capability to handle the necessary workload placed upon it. FIG. 8 illustrates a device 800 comprising an exemplary general-purpose computer system that may correspond to a combo device that implements the PSPS technique. In FIG. 8, the device 800 may be, for example, an access point or other wireless device. It should be expressly understood that any device on, for example, WLAN 700 or other embodiments, may at times be an access point and at other times be a station. It should also be understood that in some embodiments, there may be at least one dedicated access point, with any number of devices acting as stations.

As shown, the device 800 comprises at least one of any of a variety of radio frequency (RF) antennas 805 and any of a variety of wireless modems 810 that support wireless signals, wireless protocols and/or wireless communications (e.g., according to IEEE 802.11n). RF antenna 805 and wireless modem 810 are able to receive, demodulate and decode WLAN signals transmitted in a wireless network. Likewise, wireless modem 810 and RF antenna 805 are able to encode, modulate and transmit wireless signals from device 800 to other devices of a wireless network. Thus, RF antenna 805 and wireless modem 810 collectively implement the “physical layer” (PHY) for device 800. It should be appreciated that device 800 is communicatively coupled to at least one other device and/or network (e.g., a local area network (LAN), the Internet 250, or other devices). It should further be understood that illustrated antenna 805 represents one or more antennas, while the illustrated wireless modem 810 represents one or more wireless modems.

The device 800 further comprises processor(s) 820. It should be appreciated that processor 820 may be at least one of a variety of processors such as, for example, a microprocessor, a microcontroller, a central processor unit (CPU), a main processing unit (MPU), a digital signal processor (DSP), an advanced reduced instruction set computing (RISC) machine, an (ARM) processor, etc. Processor 820 executes coded instructions 855 which may be present in a main memory of the processor 820 (e.g., within a random-access memory (RAM) 850) and/or within an on-board memory of the processor 820. Processor 820 communicates with memory (including RAM 850 and read-only memory (ROM) 860) via bus 845. RAM 850 may be implemented by dynamic RAM (DRAM), synchronous dynamic RAM (SDRAM), and/or any other type of RAM device. ROM 860 may be implemented by flash memory and/or any other type of memory device.

Processor 820 implements MAC 830 using one or more of any of a variety of software, firmware, processing thread(s) and/or subroutine(s). MAC 830 provides medium access controller (MAC) functionality and further implements, executes and/or carries out functionality to facilitate, direct and/or cooperate in avoiding avalanche effect. In accordance with at least some embodiments, the MAC 830 avoids the avalanche effect by employing the PSPS technique. The MAC 830 is implemented by executing one or more of a variety of software, firmware, processing thread(s) and/or subroutine(s) with the example processor 820. Further, the MAC 830 may be, additionally or alternatively, implemented by hardware, software, firmware or a combination thereof, including using an application specific integrated circuit (ASIC), a programmable logic device (PLD), a field programmable logic device (FPLD), discrete logic, etc.

The device 800 also preferably comprises at least one input device 880 (e.g., keyboard, touchpad, buttons, keypad, switches, dials, mouse, track-ball, voice recognizer, card reader, paper tape reader, etc.) and at least one output device 885 (e.g., liquid crystal display (LCD), printer, video monitor, touch screen display, a light-emitting diode (LED), etc.)—each of which are communicatively connected to interface 870.

As shown, interface 870 also communicatively couples a wireless modem 810 with the processor 820 and/or the MAC 830. Interface 870 provides an interface to, for example and not by way of limitation, Ethernet cards, universal serial bus (USB), token ring cards, fiber distributed data interface (FDDI) cards, network interface cards, wireless local area network (WLAN) cards, or other devices that enable device 800 to communicate with other devices and/or to communicate via Internet 750 or intranet. With such a network connection, it is contemplated that processor(s) 820 would be able to receive information from at least one type of network technology and/or output information to at least one type of network technology in the course of performing the herein-described processes. It should be appreciated that interface 870 may implement at least one of a variety of interfaces, such as en external memory interface, serial port, communication internal to device 800, general purpose input/output (I/O), etc.

As shown in FIG. 8, the device 800 comprises network technology subsystems 840_{A}-840_{N}, where N is the number network technology subsystems in device 800. In accordance with embodiments, device 800 comprises at least two dissimilar network technology subsystems 840. As a result, device 800 is said to have coexisting network technologies. “Dissimilar” is used in this context to mean that at least one of the subsystems 840 is from a different network technology than another one of the subsystems 840. It should be understood that some embodiments of subsystems 840 may have their own dedicated wireless modem and antenna, while other embodiments may share either or both of a wireless modem and antenna. Examples of network technologies that may be represented by such subsystems include, but are not limited to, worldwide interoperability for microwave access (WiMAX) networks, wireless local area network (WLAN) networks, long term evolution (LTE) mobile telephony networks, personal area networks (PANs), wireless universal serial bus (USB) networks, BLUETOOTH (BT) networks, ZigBee/IEEE 801.15.4, etc. In accordance with embodiments, processor 820 interacts with network technology subsystems 840 via interfaces implemented by interface 870. It should be appreciated that, for the ease of illustration, only two or three such network technologies may be discussed in connection with any particular embodiment. However, the techniques described herein apply equally to devices having other amounts of technologies onboard a device.

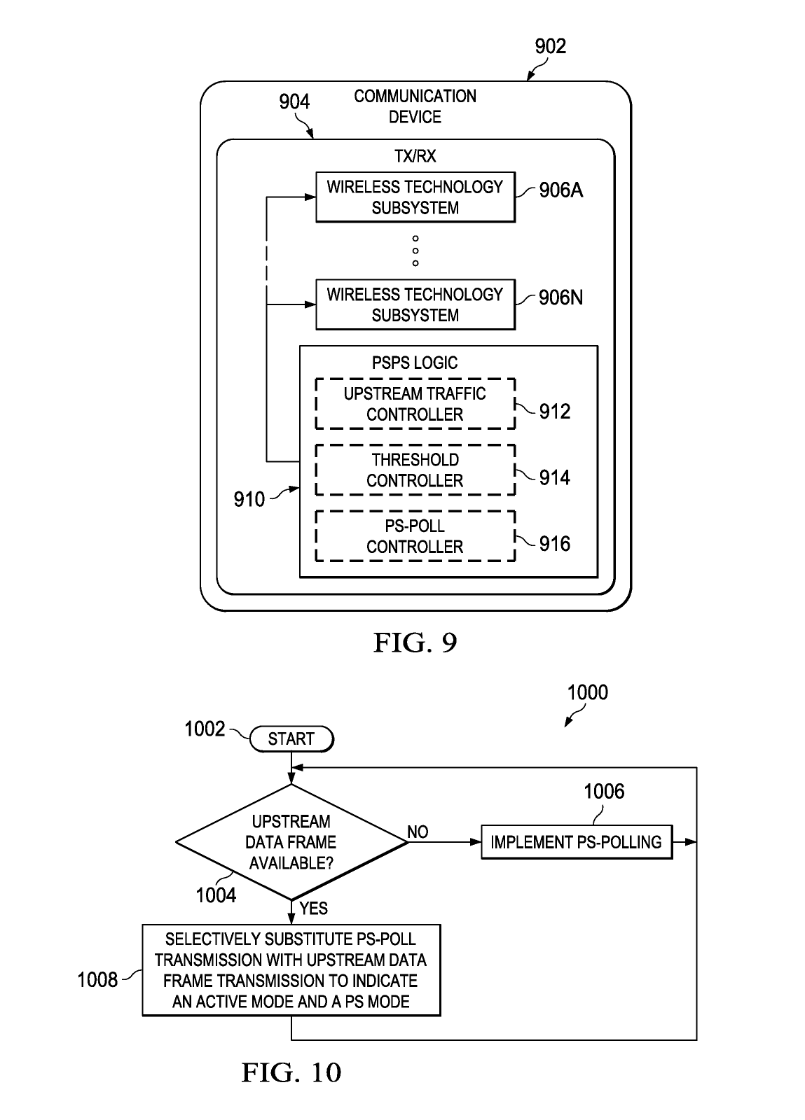

FIG. 9 illustrates a simplified communication device 902 in accordance with an embodiment of the disclosure. The communication device 902 is representative of a combo device as described herein. As shown, the communication device 902 comprises a transceiver (TX/RX) 904 having a plurality of wireless technology subsystems 906A-906N. At least two of the wireless technology subsystems 906A-906N operate at relatively close or overlapping frequency bands with respect to each other such that coexistence interference occurs during simultaneous emissions (e.g., out-of-band emissions by either technology may saturate the receiver of the other technology resulting in potential blocking). To compensate for such coexistence interference and to avoid the avalanche effect, the transceiver 904 comprises PSPS logic 910. In general, the PSPS logic 910 selectively substitutes Power-Save (PS)-Poll transmission with upstream data frame transmission to indicate an active mode and a PS mode of the communication device 902. To achieve this, the PSPS logic 910 comprises an upstream traffic controller 912, a threshold controller 914 and a PS-Poll controller 916. The PSPS logic 910 may be implemented, for example, by a media access control (MAC) layer of the transceiver 904.

In accordance with at least some embodiments, the upstream traffic controller 912 detects whether at least one upstream data frame is available as a substitute for PS-Poll transmission. If so, the upstream traffic controller 912 modifies a header of an available upstream data frame to indicate the communication device 902 is in an active mode. Alternatively, the upstream traffic controller 912 modifies a header of an available upstream data frame to indicate the communication device is in a PS mode. As an example, if an access point indicates that there is pending data for the communication device 902, the upstream traffic controller 912 may transmit an upstream data frame with a modified header to indicate to the access point that the communication device 902 is in an active mode and thus can receive the pending data. Subsequently, if an access point indicates that there is no more pending data for the communication device 902, the upstream traffic controller 912 may transmit an upstream data frame with a modified header to indicate to the access point that the communication device 902 is in a PS mode.

In accordance with at least some embodiments, the threshold controller 914 determines a threshold within a medium grant duration of the communication device 902, before which PS-Poll substitution is permitted and after which transmission of PS-Poll substitution is avoided. As an example, the threshold may a default value based on a predetermined medium grant duration for the communication device (e.g., the middle of the predetermined medium grant duration may be selected as the default threshold). Additionally or alternatively, the threshold may be dynamic during operation of the communication device 902. For example, the threshold may be shifted forward in a medium grant duration of the communication device 902 if PS-Poll substitution to indicate the PS mode of the communication device 902 previously failed. Alternatively, the threshold may be shifted back in a medium grant duration of the communication device 902 if PS-Poll substitution to indicate the PS mode of the communication device 902 previously succeeded.

In accordance with at least some embodiments, the PS-Poll controller 916 provides PS-Polling in accordance with FIGS. 2-4. Although such PS-Polling is a known technique, applying such PS-Polling in combination with PSPS is novel. In some embodiments, the PS-Poll controller 916 only performs PS-Polling if the upstream traffic controller 912 determines that there are no available upstream data frames available for PSPS.

FIG. 10 shows a method 1000 for a communication device (e.g., a combo device such as communication device 902) in accordance with an embodiment of the disclosure. As shown, the method 1000 starts at block 1002 and continues by determining whether an upstream data frame is available (determination block 1004). If there are no available upstream data frames (determination block 1004), the method 1000 may comprise implementing PS-Polling (block 1006) before returning to determination block 1004. If there are available upstream data frames (determination block 1004), the method 1000 comprises selectively substituting PS-Poll transmission with upstream data frame transmission to indicate an active mode and a PS mode of the communication device (block 1008) before returning to determination block 1004.

In accordance with at least some embodiments, the method 1000 may comprise additional steps that are added individually or in combination. For example, the method 1000 may additionally comprise modifying an upstream data frame header to indicate the active mode or the PS mode of the communication device. The method 1000 may additionally comprise maintaining a threshold during each medium grant duration of the communication device, wherein PS-Poll substitution is permitted before the threshold, but not after the threshold.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A system, comprising:
an access point; and
a station in communication with the access point, the station having at least two network technology subsystems subject to coexistence interference,
wherein the station selectively implements Power Save (PS)-Poll substitution (PSPS) logic to handle communications between the station and the access point.

2. The system of claim 1 wherein the PSPS logic determines if an upstream data frame is available for transmission from the station to the access point and wherein the PSPS logic selectively causes available upstream data frames to indicate to the access point that the station is in an active mode or a PS mode.

3. The system of claim 2 wherein, if an upstream data frame is determined to be available and if the access point indicates that there is pending data for the station, the PSPS logic causes the upstream data frame to be transmitted with a modified header that indicates to the access point that the station is in an active mode.

4. The system of claim 2 wherein, if an upstream data frame is determined to be available and if the access point indicates that there is no pending data for the station, the PSPS logic causes the upstream data frame to be transmitted with a modified header that indicates to the access point that the station is in a PS mode.

5. The system of claim 2 wherein, if an upstream data frame is determined to be unavailable or unusable, the station transmits a NULL frame to the access point to indicate to the access point that the station is in the PS mode.

6. The system of claim 1 wherein the PSPS logic maintains a threshold, before which transmission of PSPS packets is permitted and after which transmission of PSPS packets is avoided.

7. The system of claim 6 wherein the threshold has a default value based on a predetermined medium grant duration.

8. The system of claim 6 wherein the threshold is updated based on traffic conditions.

9. The system of claim 1 wherein, if the PSPS logic determines that upstream data frames are not available for transmission from the station to the access point, the PSPS logic implements a PS-Poll technique for communications between the station and the access point.

10. A communication device, comprising:
a transceiver with a first wireless technology subsystem and a second wireless technology subsystem, the first and second wireless technology subsystems being subject to coexistence interference,
wherein, to avoid an avalanche effect, the transceiver comprises logic that selectively substitutes Power-Save (PS)-Poll transmission with upstream data frame transmission to indicate an active mode and a PS mode of the communication device.

11. The communication device of claim 10 wherein the logic comprises an upstream traffic controller that detects whether at least one upstream data frame is available as a substitute for PS-Poll transmission.

12. The communication device of claim 11 wherein the upstream traffic controller modifies a header of an available upstream data frame to indicate the communication device is in an active mode or a PS mode.

13. The communication device of claim 10 wherein the logic comprises a threshold controller that determines a threshold, before which PS-Poll substitution is permitted and after which transmission of PS-Poll substitution is avoided.

14. The communication device of claim 13 wherein the threshold has a default value based on a predetermined medium grant duration for the communication device.

15. The communication device of claim 13 wherein the threshold is shifted forward in a medium grant duration of the communication device if PS-Poll substitution to indicate the PS mode previously failed.

16. The communication device of claim 13 wherein the threshold is shifted back in a medium grant duration of the communication device if PS-Poll substitution to indicate the PS mode previously succeeded.

17. The communication device of claim 10 wherein the logic is implemented by a media access control (MAC) layer of the transceiver.

18. A method for a communication device, comprising:
determining whether an upstream data frame is available; and
if there is an available upstream data frame, selectively substituting Power-Save (PS)-Poll transmission with upstream data frame transmission to indicate an active mode and a PS mode of the communication device.

19. The method of claim 18 further comprising modifying an upstream data frame header to indicate the active mode or the PS mode of the communication device.

20. The method of claim 18 further comprising maintaining a threshold during each medium grant duration of the communication device, wherein PS-Poll substitution is permitted before the threshold, but not after the threshold.
